(19) United States
(12) Patent Application Publication
(10) Pub. No.: US 2011/0221727 A1
(43) Pub. Date: Sep. 15, 2011

(54) METHOD OF DRIVING DISPLAY PANEL AND DISPLAY APPARATUS FOR PERFORMING THE SAME

(75) Inventors: Kwi-Hyun KIM, Suwon-si (KR); Kee-Bum PARK, Cheonan-si (KR); Byoung-Sun NA, Hwaseong-si (KR); Kyong-Sik CHOI, Cheonan-si (KR)

(73) Assignee: SAMSUNG ELECTRONICS CO., LTD., Suwon-si (KR)

(21) Appl. No.: 12/917,036

(22) Filed: Nov. 1, 2010

(30) Foreign Application Priority Data
Mar. 10, 2010 (KR) 2010-0021054

(51) Int. Cl. G06F 3/038

(52) U.S. Cl. 345/209; 345/96

(57) ABSTRACT

A display panel includes first and second data lines and a first pixel column containing pixels that are alternately connected to the first and second data lines. In a method of driving the display panel, a second data voltage having a first polarity is outputted to the second data line during an N-th horizontal period. A first data voltage having a second polarity phase-inverted with respect to the first polarity and a first compensating voltage having the second polarity are respectively outputted to the first data line during first and second intervals of the N-th horizontal period. The first data voltage having the second polarity is outputted to the first data line during an (N+1)-th horizontal period. The second data voltage having the first polarity and a second compensating voltage having the first polarity are respectively outputted to the second data line during first and second intervals of the (N+1)-th horizontal period.

### CROSS REFERENCE TO RELATED APPLICATION

This application claims priority from and the benefit of Korean Patent Application No. 2010-0021054, filed on Mar. 10, 2010, which is hereby incorporated by reference for all purposes as if fully set forth herein.

### BACKGROUND OF THE INVENTION

1. Field of the Invention

Exemplary embodiments of the present invention relate to a method of driving a display panel and a display apparatus for performing the method. More particularly, exemplary embodiments of the present invention relate to a method of driving a display panel used for a liquid crystal display apparatus and a liquid crystal display apparatus for performing the method.

2. Discussion of the Background

Generally, when an electric field having a uniform direction is continuously applied to a liquid crystal display (LCD) apparatus, a characteristic, for example, alignment, of a liquid crystal of the LCD apparatus may be degraded. In order to prevent the degradation of the alignment characteristic of the liquid crystal, an inversion driving method, which inverts the phase of a data voltage applied to the liquid crystal with respect to a common voltage over a period of time, may be used, thereby redirecting the alignment of the liquid crystals and minimizing alignment deterioration. One inversion driving method is a dot inversion method (DIM) which inverts a phase of each pixel or each dot.

When employing the DIM, the degradation of the characteristic of the liquid crystal may be prevented, however, power consumption of the LCD apparatus may be high. In order to decrease the power consumption of the LCD apparatus, a column inversion method, which applies data voltages having polarities different from each other to data lines adjacent to each other, is employed. In addition, in order to obtain a dot inversion effect using the column inversion method, pixels in a single column are alternately connected to the data lines adjacent to each other.

However, in the above-mentioned pixel structure, a parasitic capacitance between pixels and the data lines may cause differences of kickback voltages to be generated between two pixels adjacent to each other along a column direction. Charging rates of the two adjacent pixels may be different from each other because of the difference of the kickback voltages. Consequently, the difference in the charging rates may produce luminance differences between the two adjacent pixels. Accordingly, a horizontal line pattern may be formed on a display panel that uses the column inversion method.

In addition, when the pixels are formed on the display substrate, they may be shifted closer to one of the adjacent data lines. In this case, the difference of the charging rates between the two adjacent pixels may be greater.

### SUMMARY OF THE INVENTION

Exemplary embodiments of the present invention provide a method of driving a display panel to remove display defects.

Exemplary embodiments of the present invention also provide a display apparatus for performing the above-mentioned method.

Exemplary embodiments of the present invention further provide a display apparatus whereby a difference of kickback voltages between two pixels to which data lines adjacent to each other are alternately connected and to which data voltages having opposite polarities are applied may be compensated so that a horizontal line pattern may be prevented. Therefore, display quality of a display apparatus may be improved.

Additional features of the invention will be set forth in the description which follows, and in part will be apparent from the description, or may be learned by practice of the invention.

An exemplary embodiment of the present invention discloses a method of driving a display panel where the display panel comprises a first data line, a second data line adjacent to the first data line, and a first pixel column disposed between the first data line and the second data line and electrically connected to the first data line and the second data line. The method comprises outputting a second data voltage having a first polarity to the second data line during an N-th horizontal period, a first data voltage having a second polarity phase-inverted with respect to the first polarity to the first data line during a first interval of the N-th horizontal period, and a first compensating voltage having the second polarity to the first data line during a second interval of the N-th horizontal period, “N” being a natural number; and outputting the first data voltage having the second polarity to the first data line during an (N+1)-th horizontal period, the second data voltage having the first polarity to the second data line during a first interval of the (N+1)-th horizontal period and a second compensating voltage having the first polarity to the second data line during a second interval of the (N+1)-th horizontal period.

An exemplary embodiment of the present invention also discloses a method of driving a display panel where the display panel comprising a first data line and a second data line, the first data line being disposed between a first pixel column and a second pixel column adjacent to the first pixel column and being partially connected to the first pixel column and the second pixel column, the second data line being disposed between the second pixel column and a third pixel column adjacent to the second pixel column and being partially connected to the second pixel column and the third pixel column. The method comprises comparing first column data, second column data, and third column data respectively corresponding to the first pixel column, the second pixel column, and the third pixel column to generate a compensating voltage for a data voltage having a high grayscale among data voltages outputted to the first data line and the second data line; and outputting the data voltage having the high grayscale and the compensating voltage to the data line outputting the data voltage having the high grayscale.

An exemplary embodiment of the present invention further discloses a display apparatus that comprises a display panel comprising a first data line, a second data line adjacent to the first data line, and a first pixel column disposed between the first data and the second data line and partially connected to the first data line and the second data line. The display apparatus also comprises a panel driver to output a second data voltage having a first polarity to the second data line during an N-th horizontal period, “N” being a natural number, a first data voltage having a second polarity phase-inverted with respect to the first polarity to the first data line during a first interval of the N-th horizontal period, a first compensating voltage having the second polarity to the first data line during a second interval of the N-th horizontal period, the first data voltage having the second polarity to the first data line during an (N+1)-th horizontal period, the second data voltage having the first polarity to the second data line during a first interval of the (N+1)-th horizontal period, and a second compensating voltage having the first polarity to the second data line during a second interval of the (N+1)-th horizontal period.

An exemplary embodiment of the present invention additionally discloses a display apparatus that comprises a display panel comprising a first data line and a second data line, the first data line being disposed between a first pixel column and a second pixel column adjacent to the first pixel column and being partially connected to the first pixel column and the second pixel column, the second data line being disposed between the second pixel column and a third pixel column adjacent to the second pixel column and being partially connected to the second pixel column and the third pixel column. The display apparatus also comprises a panel driver comparing first column data, second column data, and third column data respectively corresponding to the first pixel column, the second pixel column, and the third pixel column to generate a compensating voltage for a data voltage having a high grayscale among data voltages outputted to the first data line and the second data line and to output the data voltage having the high grayscale and the compensating voltage to the data line outputting the data voltage having the high grayscale.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a display apparatus according to an exemplary embodiment of the present invention.

FIG. 2 is a plan view of the display panel of FIG. 1.

FIG. 3 is a detailed block diagram for the data driver of FIG. 1.

FIG. 4 is a timing diagram for a method of driving the display panel of FIG. 2.

FIG. 5 is a block diagram for a display apparatus according to another exemplary embodiment of the present invention.

FIG. 6 is a plan view of the display panel of FIG. 5.

FIG. 7 is a flow chart for a method of driving the display panel of FIG. 6.

FIG. 8 is a timing diagram for a method of driving the display panel of FIG. 6.

### DETAILED DESCRIPTION OF THE ILLUSTRATED EMBODIMENTS

The invention is described more fully hereinafter with reference to the accompanying drawings in which embodiments of the invention are shown. This invention may, however, be embodied in many different forms and should not be construed as limited to the embodiments set forth herein. Rather, these embodiments are provided so that this disclosure is thorough and will fully convey the scope of the invention to those skilled in the art. In the drawings, the size and relative sizes of layers and regions may be exaggerated for clarity. Like reference numerals in the drawings denote like elements

It will be understood that when an element or layer is referred to as being “on,” “connected to,” or “coupled to” another element or layer, it can be directly on, directly connected to, directly coupled to the other element or layer, or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms such as first, second, and third may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

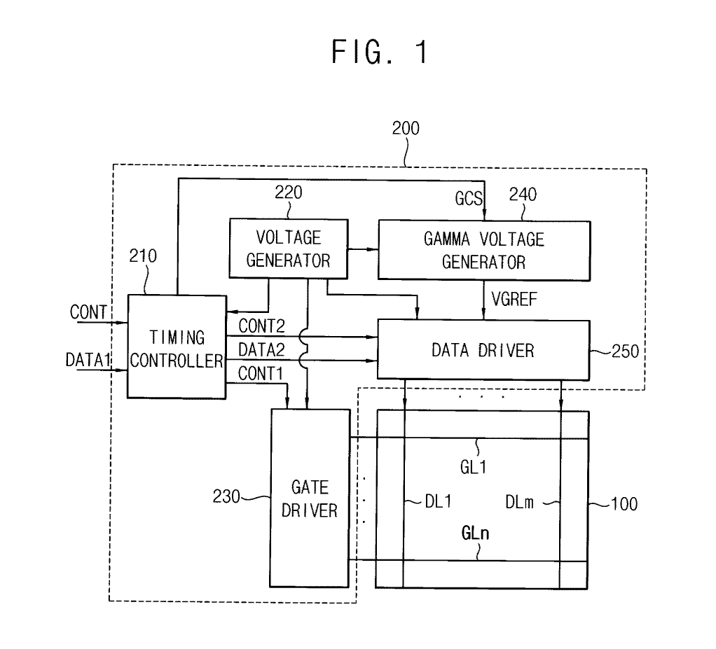

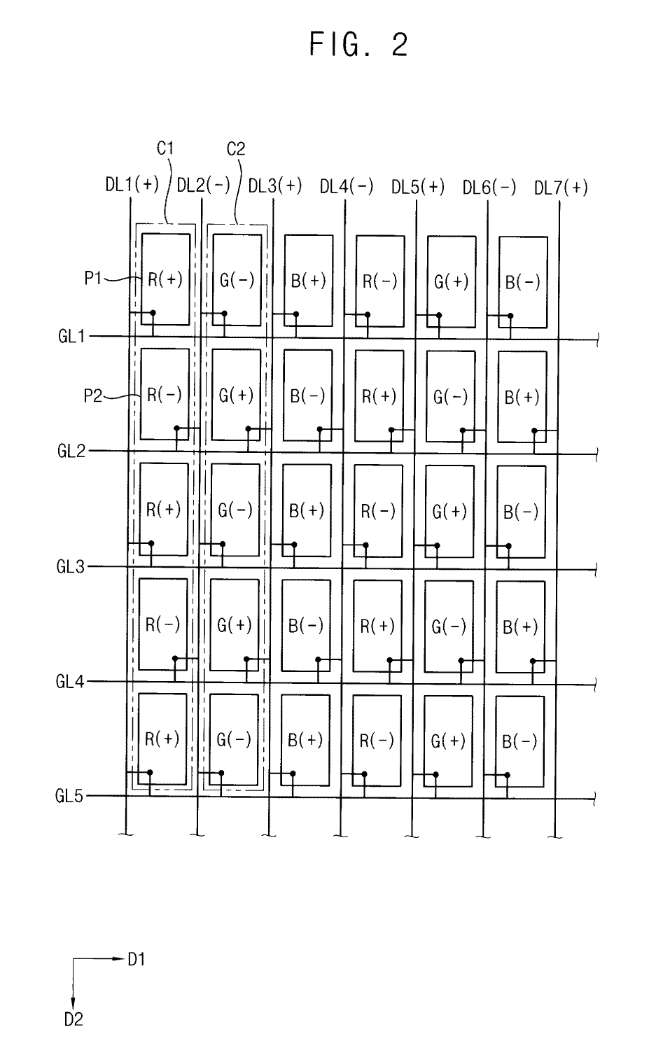

FIG. 1 is a block diagram showing a display apparatus according to an exemplary embodiment of the present invention. FIG. 2 is a plan view of a display panel of FIG. 1.

Referring to FIG. 1 and FIG. 2, the display apparatus includes a display panel 100 and a panel driver 200 to drive the display panel 100.

The display panel 100 includes a plurality of gate lines GL1 to GLn, a plurality of data lines DL1 to DLm, and a plurality of pixels P. The gate lines GL1 to GLn extend in a first direction D1, and the data lines DL1 to DLm extend in a second direction D2 and cross the first direction D1. Each pixel P includes a driving element (not shown), a liquid crystal capacitor (not shown) and a storage capacitor (not shown). The liquid crystal capacitor and the storage capacitor are electrically connected to the driving element. The pixels P include a plurality of pixel columns C disposed in the second direction D2. The pixels in each pixel column are alternately connected to two adjacent data lines.

For example, a first pixel column C1 is disposed between a first data line DL1 and a second data line DL2. A second pixel column C2 adjacent to the first pixel column C1 is disposed between the second data line DL2 and a third data line DL3. The pixels in the first pixel column C1 are alternately connected to the first and second data lines DL1 and DL2, and the pixels in the second pixel column C2 are alternately connected to the second and third data lines DL2 and DL3. Data voltages having opposite polarities are applied to the adjacent data lines. For example, when a data voltage having a positive polarity (+) is applied to the first data line, a data voltage having a negative polarity (−), i.e., phase-inverted with respect to the positive polarity (+), is applied to the second data line. A data line having the positive polarity (+) is applied to the third data line DL3. Accordingly, inverted data voltages having a sequence of polarities of +, −, +, −, +, . . . are respectively applied to the pixels in the first pixel column C1, and inverted data voltages having a sequence of polarities of −, +, −, +, −, . . . are respectively applied to the pixels in the second pixel column C2. The first pixel column C1 includes a first pixel P1, which is connected to the first gate line GL1 and the first data line DL1, and a second pixel P2, which is connected to the second gate line GL2 and the second data line DL2.

As a result, the display panel 100 represents a 1×1 dot inversion effect, that is, alternating pixels are inverted in the first direction D1 and the second direction D2 by a column inversion method.

The panel driver 200 may include a timing controller 210, a voltage generator 220, a gate driver 230, a gamma voltage generator 240, and a data driver 250.

The timing controller 210 receives a control signal CONT and an input image signal DATA1 from a source external to the panel driver 200. The timing controller 210 converts the input image signal DATA1 to a digital data signal DATA2 to satisfy an operating condition of the display panel 100, and the timing controller 210 provides the digital data signal DATA2 to the data driver 250. The control signal CONT may include a main clock signal, a vertical synchronizing signal, a horizontal synchronizing signal, a data enable signal, etc.

The timing controller 210 generates, using the control signal CONT, a first control signal CONT1 controlling a driving timing of the gate driver 230 and a second control signal CONT2 controlling a driving timing of the data driver 250. The first control signal CONT1 may include a vertical start signal, a gate clock signal, and an output enable signal OE. The second control signal CONT2 may include a horizontal start signal, a load signal TP, an inverting signal, and a data clock signal. The timing controller 210 generates and provides a gamma control signal GCS to the gamma voltage generator 240.

The voltage generator 220 generates a driving voltage to drive the display apparatus using an external voltage provided from a source external to the panel driver 200. For example, the driving voltage may include a gate ON voltage VON and a gate OFF voltage VOFF to drive the gate driver 230, a data driving voltage to drive the data driver 250, a common voltage VCOM applied to the liquid crystal capacitor, a storage voltage applied to the storage capacitor, etc.

The gate driver 230 generates gate signals to drive the gate lines GL1 to GLn using the first control signal CONT1 provided from the timing controller 210 and the gate ON voltage VON and the gate OFF voltage VOFF provided from the voltage generator 220. The gate driver 230 sequentially outputs the gate signals to the gate lines GL1 to GLn.

The gate driver 230 may be directly integrated on the display panel 100. For example, the gate driver 230 may include a plurality of thin-film transistors (TFTs) formed by the same process as a process of forming a TFT in a position corresponding to a pixel of the display panel 100. The gate driver 230 may also be mounted on the display panel 100 using a chip type mounting method or a tape carrier package (TCP) type mounting method.

The gamma voltage generator 240 uses the gamma control signal GCS provided from the timing controller 210 to generate and output a plurality of gamma reference voltages VGREF to the data driver 250. For example, the gamma voltage generator 240 may include a resistor string circuit having a plurality of resistors connected to one another in series, which divide a source voltage and a ground voltage into the gamma reference voltages VGREF.

The data driver 250 receives the second control signal CONT2 and the digital data signal DATA2 from the timing controller 210 and the gamma reference voltages VGREF from the gamma voltage generator 240. The data driver 250 converts the digital data signal DATA2 to an analog data voltage using the gamma reference voltages VGREF and outputs the analog data voltage to the data lines DL1 to DLm.

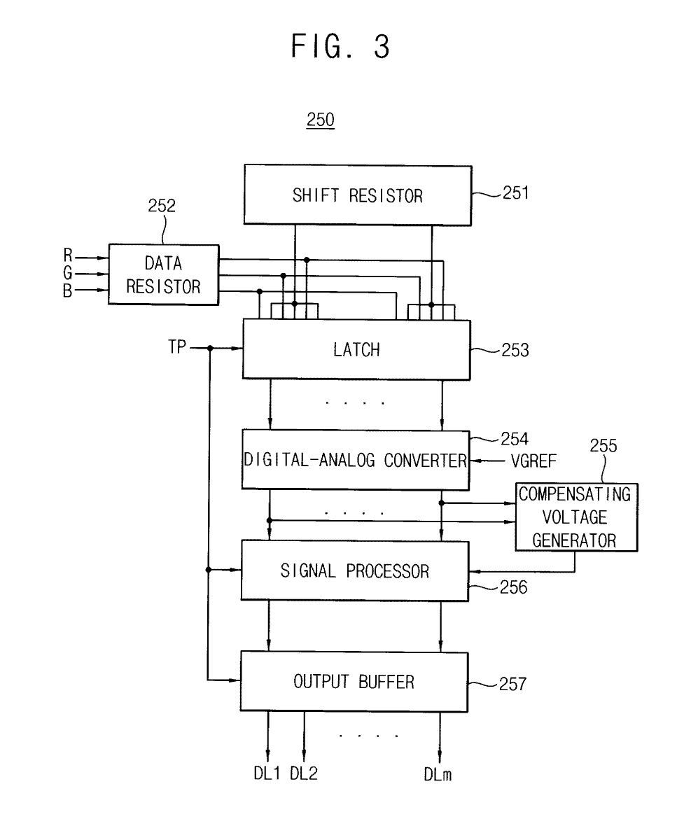

FIG. 3 is a detailed block diagram for the data driver of FIG. 1.

Referring to FIG. 1, FIG. 2, and FIG. 3, the data driver 250 may include a shift resistor 251, a data resistor 252, a latch 253, a digital-analog converter 254, a compensating voltage generator 255, a signal processor 256, and an output buffer 257.

The shift resistor 251 outputs a latch pulse to the latch 253. The data resistor 252 outputs the digital data signal DATA2 such as red, green, and blue data signals R, G, and B in response to the latch pulse provided from the shift resistor 251 to the latch 253.

The latch 253 temporarily stores the digital data signals DATA2 outputted from the data resistor 252 and outputs the digital data signals DATA2.

The digital-analog converter 254 converts the digital data signals DATA2 outputted from the latch 253 to an analog data voltage based on the gamma reference voltages VGREF. The digital-analog converter 254 includes a first digital-analog converter to convert the digital data signal DATA2 to the analog data voltage having a first polarity and a second digital-analog converter to convert the digital data signal DATA2 to the analog data voltage having a second polarity that is phase-inverted with respect to the first polarity.

The compensating voltage generator 255 generates a first compensating voltage to compensate a kickback voltage between the first pixel P1 and the second data line DL2 and a second compensating voltage to compensate a kickback voltage between the second pixel P2 and the first data line DL1. For example, the compensating voltage generator 255 may generate the first and second compensating voltages using a first data voltage applied to the first pixel P1 and a second data voltage applied to the second pixel P2. The compensating voltage generator 255 increases or decreases levels of the first and second data voltages by a certain level according to the polarity of the first and second data voltages to generate the first and second compensating voltages. The level may be changed according to a grayscale of the digital data signal DATA2.

The first and second compensating voltages respectively have the same polarities as the first and second data voltages. For example, as shown in FIG. 2, when the first data voltage having the first polarity is applied to the first data line DL1 and the second data voltage having the second polarity phase-inverted with respect to the first polarity is applied to the second data line DL2, the first compensating voltage has the first polarity, and the second compensating voltage has the second polarity. Herein, when the first polarity is the positive (+) polarity with respect to a reference voltage, the second polarity is the negative (−) polarity with respect to the reference voltage. When the first data voltage has the positive (+) polarity and the second data voltage has the negative (−) polarity, the compensating voltage generator 255 decreases the first data voltages by a first level to generate the first compensating voltage and increases the second data voltages by a second level to generate the second compensating voltage. Herein, the first level and the second level may be equal to each other or may be different from each other. The first compensating voltage has a level lower than that of the first data voltage, and the second compensating voltage has a level higher than that of the second data voltage. The level is with respect to the reference voltage.

The signal processor 256 is synchronous with the load signal TP applied from the timing controller 210 to output the first and second data voltages and the first and second compensating voltages. The signal processor 256 processes the second data voltage, the first data voltage, and the first compensating voltage. Accordingly, the second data voltage having the first polarity is outputted to the second data line DL2 during an N-th horizontal period. The first data voltage having the second polarity phase-inverted with respect to the first polarity is outputted to the first data line DL1 during a first interval of the N-th horizontal period, and the first compensating voltage having the second polarity is outputted to the first data line DL1 during a second interval of the N-th horizontal interval. In addition, the signal processor 256 processes the first data voltage so that the first data voltage having the second polarity is outputted during an (N+1)-th horizontal period. The signal processor 256 processes the second data voltage and the second compensating voltage so that the second data voltage having the second polarity is outputted during a first interval of the (N+1)-th horizontal period, and the second compensating voltage having the first polarity is outputted during a second interval of the (N+1)-th horizontal period.

In other words, a second data voltage having a first polarity is outputted to the second data line during an N-th horizontal period. A first data voltage having a second polarity phase-inverted with respect to the first polarity and a first compensating voltage having the second polarity are respectively outputted to the first data line during first and second intervals of the N-th horizontal period. The first data voltage having the second polarity is outputted to the first data line during an (N+1)-th horizontal period. The second data voltage having the first polarity and a second compensating voltage having the first polarity are respectively outputted to the second data line during first and second intervals of the (N+1)-th horizontal period.

The output buffer 257 buffers the data voltage and the compensating voltage outputted from the signal processor 256 to output the data voltages and the compensating voltages.

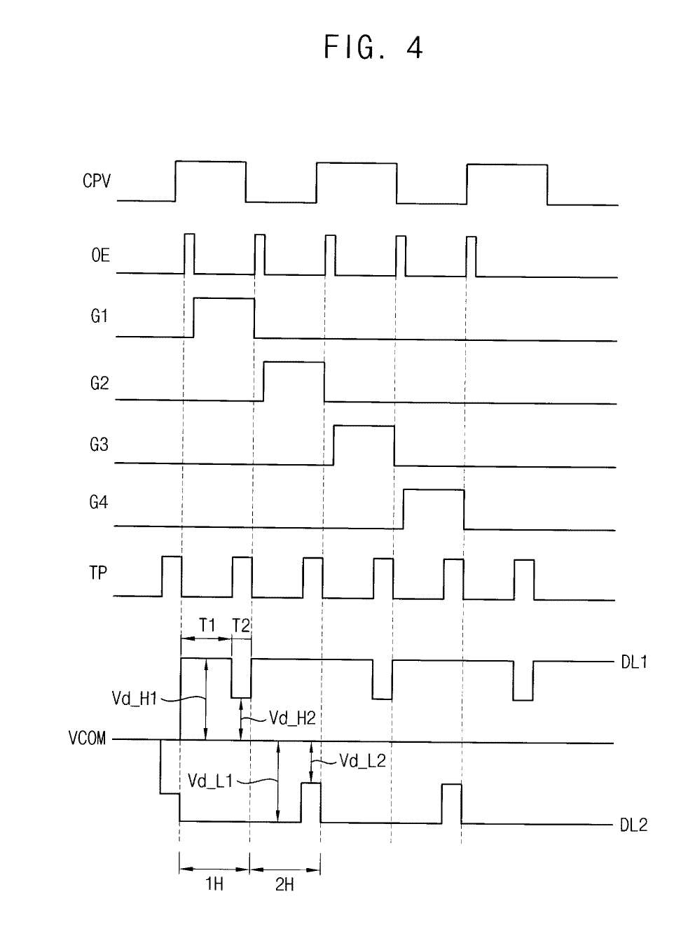

FIG. 4 is a timing diagram for a method of driving the display panel of FIG. 2.

Referring to FIG. 2 and FIG. 4, explanation is provided below for the first data voltage Vd_H1 having the positive (+) polarity and the first compensating voltage Vd_H2 having the positive (+) polarity being applied to the first data line DL1 and the second data voltage Vd_L1 having the negative (−) polarity and the second compensating voltage Vd_L2 having the negative (−) polarity being applied to the second data line DL2.

During a first horizontal period 1H in which a voltage pulse of a first gate signal G1 is applied to the first gate line GL1, the first data voltage Vd_H1 and the first compensating voltage Vd_H2 are applied to the first data line DL1. For example, the first data voltage Vd_H1 is outputted to the first data line DL1 during a first interval T1 of the first horizontal period 1H, and the first compensating voltage Vd_H2 is outputted to the first data line DL1 during a second interval T2 of the first horizontal period 1H. The second interval T2 is defined as an interval excluding the first interval T1 in the first horizontal period 1H.

The second data voltage Vd_L1 is outputted to the second data line DL2 during the first horizontal period 1H. The first compensating voltage Vd_H2 has a level lower than that of the first data voltage Vd_H1. The second compensating voltage Vd_L2 has a level higher than that of the second data voltage Vd_L1.

Then, during a second horizontal period 2H in which a voltage pulse of a second gate signal G2 is applied to the second gate line GL2, the first data voltage Vd_H1 is applied to the first data line DL1. The second data voltage Vd_L1 is outputted to the second data line DL2 during a first interval T1 of the second horizontal period 2H, and the second compensating voltage Vd_L2 is outputted to the second data line DL2 during a second interval T2 of the second horizontal period 2H.

The first and second compensating voltages Vd_H2 and Vd_L2 are outputted to be synchronous with the load signal TP indicating an output timing of the first and second data voltages Vd_H1 and Vd_L1. For example, the first and second compensating voltages Vd_H2 and Vd_L2 are outputted in response to a rising edge of the load signal TP. The second interval T2 in which the first and second compensating voltages Vd_H2 and Vd_L2 are outputted may correspond to a pulse width of the output enable signal OE indicating an output timing of the gate signals.

In FIG. 4, the display panel 100 that may be driven in a full white mode is shown so that the level of the first data voltage Vd_H1 is maintained as a constant for all horizontal periods, and the level of the first compensating voltage Vd_H2 is also maintained as a constant for all horizontal periods. However, exemplary embodiments of the present invention are not limited thereto. For example, the level of the data voltage may be changed according to a grayscale of the input image signal corresponding to a pixel or a set of pixels. The level of the compensating voltage may also be changed according to the grayscale of the input image signal.

A kickback voltage generated by a coupling capacitance between a pixel electrode of the first pixel P1 and the second data line DL2 is compensated by the second compensating voltage Vd_L2, and a kickback voltage generated by a coupling capacitance between a pixel electrode of the second pixel P2 and the first data line DL1 is compensated by the first compensating voltage Vd_H2. Thus, the kickback voltages of the first and second pixels P1 and P2 having opposite polarities to each other may be substantially equal to each other.

Referring to FIG. 2, a method of compensating the kickback voltage is explained. For example, a kickback voltage Vk1 generated at the first pixel P1 is determined as a sum of a first kickback voltage Vk1_L generated by a coupling capacitance Cdp11 between the pixel electrode of the first pixel P1 and the first data line DL1 and a second kickback voltage Vk1_R generated by a coupling capacitance Cdp12 between the pixel electrode of the first pixel P1 and the second data line DL2.

A kickback voltage Vk2 generated at the second pixel P2 is determined as a sum of a third kickback voltage Vk2_L generated by a coupling capacitance Cdp21 between the pixel electrode of the second pixel P2 and the first data line DL1 and a fourth kickback voltage Vk2_R generated by a coupling capacitance Cdp22 between the pixel electrode of the second pixel P2 and the second data line DL2.

The second kickback voltage Vk1_R and the third kickback voltage Vk2_L may increase when the data voltage has a polarity opposite to that of a voltage charged at the pixel, such as between the pixel electrode of the first pixel P1 and the second data line DL2 and between the pixel electrode of the second pixel P2 and the first data line DL1, is applied. When the first and second pixels P1 and P2 are shifted toward the first data line DL1 due to a fabrication error, levels of the first and third kickback voltages Vk1_L and Vk2_L become greater than those of the second and fourth kickback voltages Vk1_R and Vk2_R. According to the above conditions, the level of the kickback voltage generated at the second pixel P2 may become greater than that of the kickback voltage generated at the first pixel P1. Thus, a charging rate of the second pixel P2 may be lower than the charging rate of the first pixel P1, and a luminance difference between the first and second pixels P1 and P2 may be generated, which may create a horizontal line pattern. However, according to the present exemplary embodiment, the second kickback voltage Vk1_R and the third kickback voltage Vk2_L are compensated by the first and second compensating voltages Vd_H2 and Vd_L2 so that the horizontal line pattern may be mitigated or prevented. For example, the second kickback voltage Vk1_R may be compensated by outputting the second compensating voltage Vd_L2 to the second data line DL2 having a higher level than that of the second data voltage Vd_L1 before an interval during which the first data voltage Vd_H1 outputted to the first data line DL1 is charged at the first pixel P1. In addition, the third kickback voltage Vk2_L may be compensated by outputting the first compensating voltage Vd_H2 to the first data line DL1 having a level lower than that of the first data voltage Vd_H1 before an interval during which the second data voltage Vd_L1 outputted to the second data line DL2 is charged at the second pixel P2.

According to the present exemplary embodiment, the difference of kickback voltages between the first and second pixels P1 and P2 may be compensated by the first and second compensating voltages Vd_H2 and Vd_L2 so that the horizontal line pattern may be prevented.

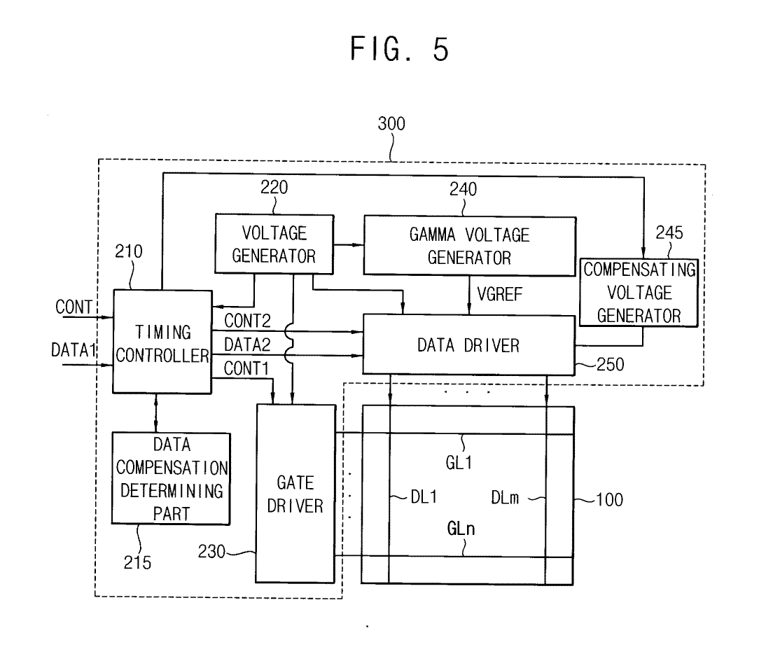

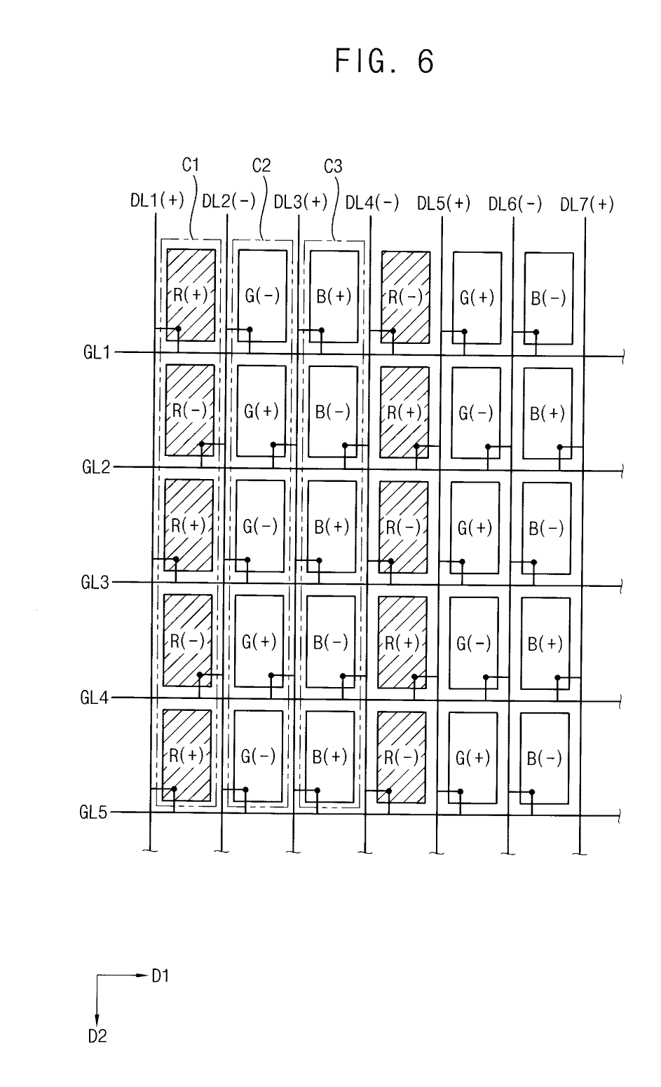

FIG. 5 is a block diagram for a display apparatus according to another exemplary embodiment of the present invention. FIG. 6 is a plan view of the display panel of FIG. 5.

The display apparatus according to the present exemplary embodiment is substantially the same as the display apparatus according to the previous exemplary embodiment shown in FIG. 1, FIG. 2, FIG. 3, and FIG. 4 except for a data compensation determining part 215 and a compensating voltage generator 245 of a panel driver 300. Thus, the same reference numerals refer to the same or like parts as those described in the previous exemplary embodiment shown in FIG. 1, FIG. 2, FIG. 3, and FIG. 4, and repetitive explanations concerning the above elements are omitted.

Referring to FIG. 5 and FIG. 6, the display apparatus may include a display panel 100, a timing controller 210, a data compensation determining part 215, a voltage generator 220, a gate driver 230, a gamma voltage generator 240, a compensating voltage generator 245, and a data driver 250.

The display panel 100 includes a plurality of gate lines GL1 to GLn, a plurality of data lines DL1 to DLm, and a plurality of pixels. The gate lines GL1 to GLn extend in a first direction D1, and the data lines DL1 to DLm extend in a second direction D2 and cross the first direction D1. The pixels include a plurality of pixel columns disposed in the second direction D2. The pixels in each pixel column alternately connect to adjacent data lines.

For example, a first pixel column C1 is disposed between a first data line DL1 and a second data line DL2. A second pixel column C2 adjacent to the first pixel column C1 is disposed between the second data line DL2 and a third data line DL3. A third pixel column C3 adjacent to the second pixel column C2 is disposed between the third data line DL3 and a fourth data line DL4. The pixels in the first pixel column C1 are alternately connected to the first and second data lines DL1 and DL2, and the pixels in the second pixel column C2 are alternately connected to the second and third data lines DL2 and DL3. The pixels in the third pixel column C3 are alternately connected to the third and fourth data lines DL3 and DL4. Data voltages having opposite polarities are applied to the data lines adjacent to each other. For example, when a data voltage having a positive polarity (+) is applied to the first data line DL1, a data voltage having a negative polarity (−) phase-inverted with respect to the positive polarity (+) is applied to the second data line DL2, and a data voltage having the positive polarity (+) is applied to the third data line DL3. Accordingly, the inverted data voltages having a sequence of polarities of +, −, +, −, +, . . . are respectively applied to the pixels in the first pixel column C1. Also, the inverted data voltages having a sequence of polarities of −, +, −, +, −, . . . are respectively applied to the pixels in the second pixel column C2, and the inverted data voltages having a sequence of polarities of +, −, +, −, +, . . . are respectively applied to the pixels in the third pixel column C3.

The data compensation determining part 215 determines whether a compensation of the data voltages applied to a specific data line is required by comparing a plurality of pixel column data provided from the timing controller 210. When the data compensation determining part 215 determines that the compensation of the data voltage is required, the data compensation determining part 215 determines compensation required data and outputs the compensation required data to the timing controller 210. For example, first column data, second column data, and third column data respectively correspond to the first, second, and third pixel columns C1, C2, and C3. When the first column data represent black data and the second and third column data represent gray data, the data compensation determining part 215 determines that compensation is required of the data voltages applied to the third data line DL3 connected to the second and third pixel columns C2 and C3. A level of the data voltage applied to the third data line DL3 disposed between the second and third pixel columns C2 and C3 is higher than that of the data voltage applied to the second data line DL2 disposed between the first and second pixel columns C1 and C2.

The data compensation determining part 215 determines the data corresponding to the pixels connected to the third data line DL3 among the second and third column data as the compensation required data. Hereinafter, an example in which the compensation of the data voltages is required similar to the above-mentioned exemplary embodiment is explained. For example, as shown in FIG. 6, the first pixel column C1 is a red pixel column including red pixels. The second pixel column C2 is a green pixel column including green pixels, and the third pixel column C3 is a blue pixel column including blue pixels. The column data of the first pixel column C1 represent black data. Thus, an image of a frame is only displayed by green and blue data. In this case, the data voltage having the negative (−) polarity and a reference voltage are alternately outputted to the second data line DL2 connected between the first pixel column C1 and the second pixel column C2. The data voltages having the positive (+) polarity are continuously outputted to the third data line DL3 connected between the second pixel column C2 and the third pixel column C3. In this case, a difference of charging rates between the pixels connected to the second data line DL2 and the pixels connected to the third data line DL3 is generated. A luminance difference is generated due to the difference of charging rates so that a horizontal line pattern may be generated on the display panel 100. As explained above, when an image is displayed by combining two colors instead of three colors, compensation of the data voltage may be required.

Although the case in which the first column data of the first pixel column C1 represent black data among the first pixel column C1, the second pixel column C2, and the third pixel column C3 is discussed in the present exemplary embodiment, exemplary embodiments of the present invention are not limited thereto. For example, the second column data or the third column data of the second pixel column C2 or the third pixel column C3 may represent black data. For example, when the second column data of the second pixel column C2 represent the black data, the compensation required data may be data corresponding to pixels connected to the fourth data line DL4 disposed between the third pixel column C3 and the fourth pixel column C4 adjacent to the third pixel column C3.

The compensating voltage generator 245 generates a compensating voltage based on the compensation required data received from the timing controller 210. The compensating voltage generator 245 converts the compensation required data to an analog data voltage. The compensating voltage generator 245 may increase or decrease a level of the analog data voltage by a certain level according to the polarity of the analog data voltage to generate the compensating voltage. The certain level may be changed according to the level of the analog data voltage. For example, when the analog data voltage has the positive (+) polarity with respect to the reference voltage, the compensating voltage generator 245 decreases the analog data voltage by a certain level to generate the compensating voltage. In contrast, when the analog data voltage has the negative (−) polarity with respect to the reference voltage, the compensating voltage generator 245 increases the analog data voltage by a certain level to generate the compensating voltage.

The data driver 250 outputs a normal data voltage, i.e., non-compensated, to the data line that does not need compensation and outputs the compensating voltage to the data line that need compensation. Similar to the date driver 250 shown in FIG. 3, the data driver 250 of FIG. 5 may include the shift resistor 251, the data resistor 252, the latch 253, the digital-analog converter 254, the signal processor 256, and the output buffer 257. The above-mentioned elements are discussed above with reference to FIG. 3 so repetitive explanations are omitted.

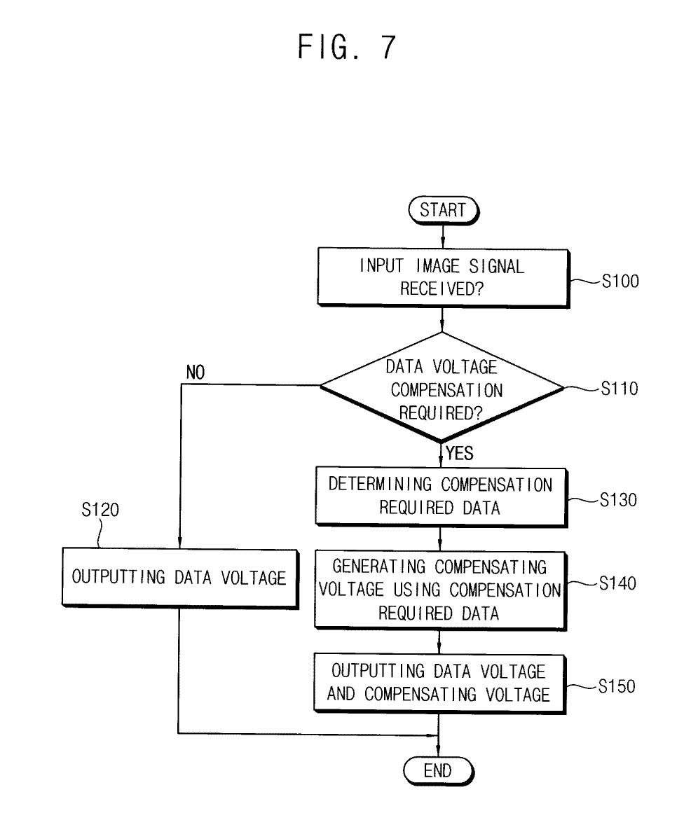

FIG. 7 is a flow chart for a method of driving the display panel of FIG. 6.

Referring to FIG. 5, FIG. 6, and FIG. 7, when the timing controller 210 receives the input image signal DATA1 (step S100), the timing controller 210 converts the input image signal DATA1 to the pixel column data corresponding to a pixel structure of the display panel 100 to output the pixel column data to the data compensation determining part 215.

The data compensation determining part 215 determines whether the data voltages applied to a specific data line are to be compensated (also referred to above as needing compensation) by comparing the pixel column data received from the timing controller 210 (step S110). For example, the first column data, the second column data, and the third column data respectively correspond to the first, second, and third pixel columns C1, C2, and C3. When the first column data represent the black data and the second and third column data represent the gray data, the data compensation determining part 215 determines that the compensation of the data voltages applied to the third data line DL3 connected to the second and third pixel columns C2 and C3 is needed.

In the step S110, when the compensation of the data voltage applied to the specific data line is not needed, the data corresponding to the pixels connected to the data line are converted to an analog data voltage to be outputted to the data line without the compensation of the data voltages (step S120).

In the step S110, when the compensation of the data voltage applied to the specific data line is needed, the data compensation determining part 215 determines the compensating voltage. The data compensation determining part 215 determines the compensation required data to compensate the data voltage (step S130). As explained above, when the compensation of the data voltage applied to the third data line DL3 connected to the second and third pixel columns C2 and C3 is needed, the compensation required data are determined. The data compensation determining part 215 determines the data corresponding to the pixels connected to the third data line DL3 among the second and third column data as the compensation required data. The compensation required data are provided to the compensating voltage generator 245 through the timing controller 210.

The compensating voltage generator 245 generates the compensating voltage using the compensation required data (step S140).

The data driver 250 outputs the normal, i.e., non-compensated, and compensating data voltages corresponding to pixels connected to specific data lines as described above (step S150).

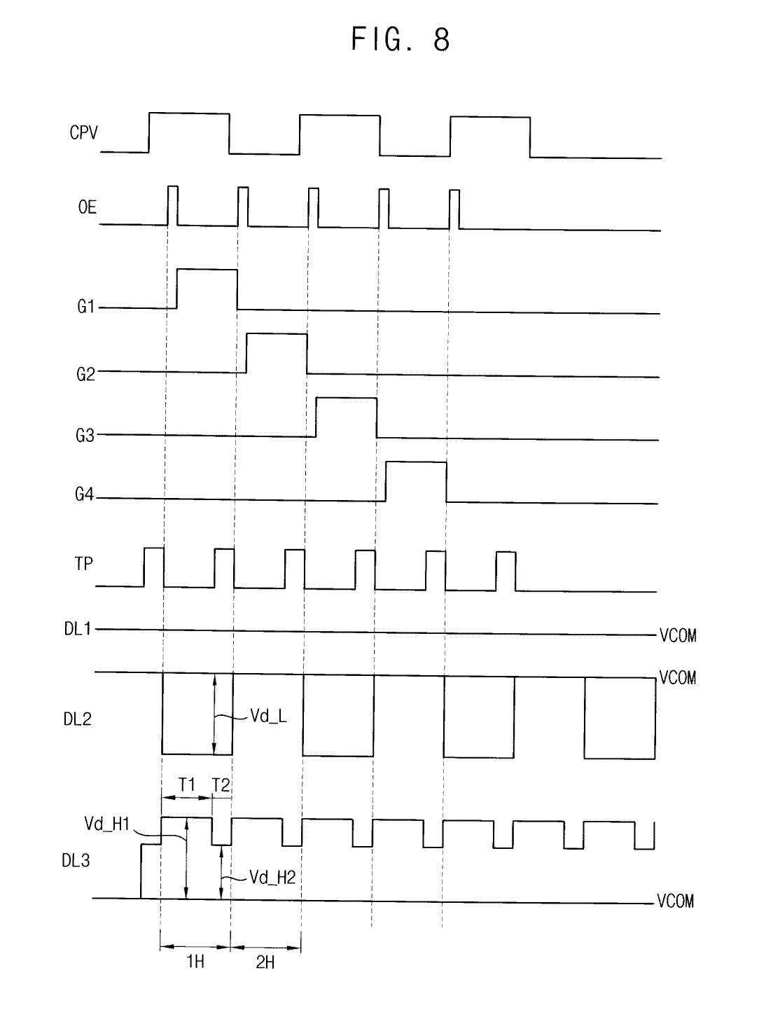

FIG. 8 is a timing diagram for a method of driving the display panel of FIG. 6.

Referring to FIG. 6 and FIG. 8, hereinafter, a case in which the first column data among the first, second, and third column data (respectively corresponding to the first, second, and third pixel columns C1, C2, and C3) represent the black data and the second and third column data represent the gray data is discussed.

During the first horizontal period 1H, when a voltage pulse of the first gate signal G1 is applied to the first gate line GL1, a reference voltage VCOM is outputted to the first data line DL1 and a data voltage Vd_L having a negative (−) polarity is outputted to the second data line DL2. The data voltage Vd_H1 having a positive (+) polarity is outputted to the third data line DL3 during a first interval T1 of the first horizontal period 1H, and the compensating voltage Vd_H2 is outputted to the third data line DL3 during a second interval T2 of the first horizontal period 1H. The second interval T2 excludes, for the most part, the first interval T1 in the first horizontal period 1H. The compensating voltage Vd_H2 has a level lower than that of the data voltage Vd_H1.

During the second horizontal period 2H, when a voltage pulse of the second gate signal G2 is applied to the second gate line GL2, a reference voltage VCOM is outputted to the first and second data lines DL1 and DL2. The data voltage Vd_H1 having the positive (+) polarity is outputted to the third data line DL3 during a first interval T1 of the second horizontal period 2H, and the compensating voltage Vd_H2 is outputted to the third data line DL3 during a second interval T2 of the second horizontal period 2H.

The data voltage Vd_H1 is outputted to the third data line DL3 during the first interval T1 of each horizontal period, and the compensating voltage Vd_H2 is outputted to the third data line DL3 during the second interval T2 of each horizontal period.

According to the present exemplary embodiment, the charging rates may be decreased for the pixels connected to the third data line DL3 having a charging rate higher than the charging rate of the pixels connected to the second data line DL2 so that a luminance difference between adjacent pixels in a column direction may be compensated. Thus, a horizontal line pattern due to the luminance difference between the adjacent pixels may be prevented.

As described above, the difference of kickback voltages between two pixels alternately connected to the adjacent data lines at which data voltages having opposite polarities are applied may be compensated so that the horizontal line pattern may be prevented. Therefore, the display quality of the display apparatus may be improved.

The foregoing is illustrative of the present invention and is not to be construed as limiting thereof. It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of driving a display panel, the display panel comprising a first data line, a second data line adjacent to the first data line, and a first pixel column disposed between the first data line and the second data line and electrically connected to the first data line and the second data line, the method comprising:
outputting a second data voltage having a first polarity to the second data line during an N-th horizontal period, a first data voltage having a second polarity phase-inverted with respect to the first polarity to the first data line during a first interval of the N-th horizontal period, and a first compensating voltage having the second polarity to the first data line during a second interval of the N-th horizontal period, “N” being a natural number; and
outputting the first data voltage having the second polarity to the first data line during an (N+1)-th horizontal period, the second data voltage having the first polarity to the second data line during a first interval of the (N+1)-th horizontal period and a second compensating voltage having the first polarity to the second data line during a second interval of the (N+1)-th horizontal period.

2. The method of claim 1, wherein the first pixel column comprises a first pixel connected to the first data line and a second pixel adjacent to the first pixel and connected to the second data line,
the first compensating voltage compensates a kickback voltage between the first pixel and the second data line, and
the second compensating voltage compensates a kickback voltage between the second pixel and the first data line.

3. The method of claim 1, wherein the first polarity is a negative polarity with respect to a reference voltage,
the second polarity is a positive polarity with respect to the reference voltage,
the first compensating voltage has a level lower than a level of the first data voltage, and
the second compensating voltage has a level higher than a level of the second data voltage.

4. A method of driving a display panel, the display panel comprising a first data line and a second data line, the first data line being disposed between a first pixel column and a second pixel column adjacent to the first pixel column and being partially connected to the first pixel column and the second pixel column, the second data line being disposed between the second pixel column and a third pixel column adjacent to the second pixel column and being partially connected to the second pixel column and the third pixel column, the method comprising:
comparing first column data, second column data, and third column data respectively corresponding to the first pixel column, the second pixel column, and the third pixel column to generate a compensating voltage for a data voltage having a high grayscale among data voltages outputted to the first data line and the second data line; and
outputting the data voltage having the high grayscale and the compensating voltage to the data line outputting the data voltage having the high grayscale.

5. The method of claim 4, wherein the compensating voltage for the data voltage outputted to the second data line is generated when the first column data represent black data and the second column data and the third column data represent gray data.

6. The method of claim 5, wherein the data voltage having the high grayscale is outputted during a first interval of a first horizontal period, and
the compensating voltage is outputted during a second interval of the first horizontal period.

7. The method of claim 4, wherein the compensating voltage has a level lower than that of the data voltage having the high grayscale when the data voltage having the high grayscale has a positive polarity with respect to a reference voltage, and
the compensating voltage has a level higher than that of the data voltage having the high grayscale when the data voltage having the high grayscale has a negative polarity with respect to the reference voltage

8. A display apparatus, comprising:
a display panel comprising a first data line, a second data line adjacent to the first data line, and a first pixel column disposed between the first data and the second data line and partially connected to the first data line and the second data line; and
a panel driver to output a second data voltage having a first polarity to the second data line during an N-th horizontal period, “N” being a natural number, a first data voltage having a second polarity phase-inverted with respect to the first polarity to the first data line during a first interval of the N-th horizontal period, a first compensating voltage having the second polarity to the first data line during a second interval of the N-th horizontal period, the first data voltage having the second polarity to the first data line during an (N+1)-th horizontal period, the second data voltage having the first polarity to the second data line during a first interval of the (N+1)-th horizontal period, and a second compensating voltage having the first polarity to the second data line during a second interval of the (N+1)-th horizontal period.

9. The display apparatus of claim 8, wherein the first pixel column comprises a first pixel connected to the first data line and a second pixel adjacent to the first pixel and connected to the second data line, and
the first compensating voltage compensates a kickback voltage between the first pixel and the second data line and the second compensating voltage compensates a kickback voltage between the second pixel and the first data line.

10. The display apparatus of claim 8, wherein the first polarity is a negative polarity with respect to a reference voltage,
the second polarity is a positive polarity with respect to the reference voltage,
the first compensating voltage has a level lower than a level of the first data voltage, and
the second compensating voltage has a level higher than a level of the second data voltage.

11. The display apparatus of claim 10, wherein levels of the first compensating voltage and the second compensating voltage change according to a grayscale of the first data voltage and a grayscale of the second data voltage corresponding to the first pixel and the second pixel, respectively.

12. A display apparatus, comprising:
a display panel comprising a first data line and a second data line, the first data line being disposed between a first pixel column and a second pixel column adjacent to the first pixel column and being partially connected to the first pixel column and the second pixel column, the second data line being disposed between the second pixel column and a third pixel column adjacent to the second pixel column and being partially connected to the second pixel column and the third pixel column; and
a panel driver comparing first column data, second column data, and third column data respectively corresponding to the first pixel column, the second pixel column, and the third pixel column to generate a compensating voltage for a data voltage having a high grayscale among data voltages outputted to the first data line and the second data line and to output the data voltage having the high grayscale and the compensating voltage to the data line outputting the data voltage having the high grayscale.

13. The display apparatus of claim 12, wherein the panel driver comprises:
a data compensation determining part to compare the first column data, the second column data, and the third column data respectively corresponding to the first pixel column, the second pixel column, and the third pixel column and to determine whether the data voltage among data voltages outputted to the first data line and the second data line needs compensation and which data needs compensation, the data needing compensation being compensation required data;
a compensating voltage generator to generate the compensating voltage based on the compensation required data; and
a data driver to output the compensating voltage and the data voltage corresponding to the compensation required data to the data line having the compensation required data of the first data line and the second data line.

14. The display apparatus of claim 13, wherein the data compensation determining part determines that the data voltage outputted to the second data line needs to be compensated and determines that data corresponding to pixels connected to the second data line among the second column data and the third column data need to be compensated when the first column data represent black data and the second column data and the third column data represent gray data.

15. The display apparatus of claim 13, wherein the data driver outputs the data voltage having the high grayscale during a first interval of a first horizontal period and outputs the compensating voltage during a second interval of the first horizontal period.

16. The display apparatus of claim 12, wherein the compensating voltage has a level lower than that of the data voltage having the high grayscale when the data voltage having the high grayscale has a positive polarity with respect to a reference voltage, and
the compensating voltage has a level higher than that of the data voltage having the high grayscale when the data voltage having the high grayscale has a negative polarity with respect to the reference voltage
